(19) United States
(12) Patent Application Publication
(10) Pub. No.: US 2015/0364824 A1
(43) Pub. Date: Dec. 17, 2015

(54) PROTECTIVE COVER FOR PORTABLE TERMINAL AND METHOD FOR MANUFACTURING SAME

(71) Applicant: AMOGREENTECH CO., LTD., Gimpo-si, Gyeonggi-do (KR)

(72) Inventors: Yong Sul SONG, Seoul (KR); Jong Su SEOK, Suwon-si (KR); Moon Hoe KIM, Gimpo-si (KR); Min Ho WON, Incheon (KR)

(73) Assignee: AMOGREENTECH CO., LTD., Gimpo-si, Gyeonggi-do (KR)

(21) Appl. No.: 14/766,208

(22) PCT Filed: Feb. 6, 2014
(86) PCT No.: PCT/KR2014/001011

§ 371 Date: Aug. 6, 2015

(30) Foreign Application Priority Data
Feb. 8, 2013 (KR) 10-2013-0014224
Apr. 24, 2013 (KR) 10-2013-0045395
May 21, 2013 (KR) 10-2013-0057266

(51) Int. Cl. H01Q 9/04; B32B 15/14; B32B 5/26; B32B 15/04; B32B 7/12; B32B 5/02

(52) U.S. Cl. CPC H01Q 9/0407; B32B 7/12; B32B 5/028; B32B 5/024; B32B 5/26; B32B 5/022; B32B 15/04; B32B 15/14; B32B 2255/06; B32B 2262/02; B32B 2262/103; B32B 2264/105; B32B 2307/202; B32B 2307/212; B32B 2457/00; B32B 37/14

(57) ABSTRACT

Provided is a protective cover for a portable terminal, the protective cover including: a cover layer; an adhesive layer that is laminated on an inner surface of the cover layer; and a metal layer that is attached on the adhesive layer to perform an electromagnetic wave shielding function. The protective cover may shield electromagnetic waves generated in a portable terminal, perform an antibacterial function contaminating the portable terminal, and carrying out a DMB receiving antenna function when the metal layer is formed in a DMB reception antenna pattern.

### TECHNICAL FIELD

The present invention relates to a protective cover that is mounted on the outer surface of a portable terminal, and for protecting the portable terminal from an external impact or contact, and more particularly to a protective cover for a portable terminal having an electromagnetic shielding function, an antibacterial function, and a DMB (digital multimedia broadcasting) reception antenna function.

### BACKGROUND ART

In general, a portable terminal is a portable electronic device that is portably available with one or more of a voice and video call function, a function of inputting and outputting information, and a function of storing data.

According to a variety of functions, the portable terminal is implemented in the form of a multimedia player with complex features, for example, such as recording of photos or videos, playback of music or video files, games, and receipt of broadcasting.

When a portable terminal has a DMB (Digital Multimedia Broadcasting) reception function, the portable terminal includes an antenna for receiving terrestrial DMB. Here, in order to achieve a good reception performance, an antenna for the terrestrial DMB reception has a relatively large size, in comparison with the size of the portable terminal and thus has an external antenna structure in which the antenna is detachable from or pulled out externally from the portable terminal.

However, the terrestrial DMB reception antenna that is externally mounted in the portable terminal should be drawn out externally when using the antenna, to thus cause inconveniences of use of the portable terminal and discomfort to carry the portable terminal, due to a sizable projection from the portable terminal. In addition, the externally mounted antenna may be damaged in the process of using the portable terminal, and thus should be always carefully handled.

Then, users always carry the portable terminal and may be exposed to the electromagnetic waves generated from the portable terminal, to thus cause a hazard problem to the users.

In addition, users handle the portable terminal by touch with a finger or fingers of the users, and various bacteria proliferate on the surface of the portable terminal to thus cause a hazard to health of the users.

As disclosed in the Korean Utility Model Registration Publication No. 20-0377332 on 21 Feb. 2005, a conventional portable terminal protection cover is made by combining an opaque synthetic resin and a transparent resin in a desired shape in which a textile inner cover is attached to an inner surface of the opaque synthetic resin, so as to act as the protective cover surrounding the outer appearance of the portable terminal in order to protect the outer surface of the portable terminal. The protective cover is configured to include: an electromagnetic wave shielding portion having a conductive metal or a conductive metal material which is laminated and attached between the non-transparent synthetic resin and the textile inner cover of the non-transparent synthetic resin; and a plurality of connection plates having connecting pieces which are bent and gripped to be connected to the electromagnetic shielding portion by passing through the non-transparent synthetic resin in which the plurality of connection plates are attached on the outer surface of the non-transparent synthetic resin as conductive metal plates so as to be connected to the electromagnetic shielding portion.

As described above, since the conventional portable terminal is configured by laminating and then attaching the electromagnetic shielding portion between the opaque synthetic resin and the textile inner cover of the opaque synthetic resin, the manufacturing process is complicated the production cost is increased.

Further, as disclosed in the Korean Patent Application Publication No. 10-2009-0002516 on 9 Jan. 2009, a conventional portable phone accessory with a built-in DMB antenna includes: a portable phone accessory body; a DMB antenna that uses a conductive fiber as a conductive body in which the conductive fiber is prepared by coating a conductive polymer having electrical properties due to the molecular structural features on the surface of the substrate fiber, and that receives DMB broadcast signal containing the audio and video signals; and a connector that is made of a conductive fiber and connects a DMB transmitter and the DMB antenna of the portable phone with each other.

As described above, since the conventional portable phone accessory with a built-in DMB antenna includes the accessory body using the conductive fiber that is prepared by coating the conductive polymer on the surface of the substrate fiber, the reception performance is lowered when compared to the case of directly using a conductive metal material.

In addition, the conductive polymer coated on the surface of the substrate fiber may be peeled off in the process of weaving the conductive fiber in an antenna pattern, and when the conductive polymer material is peeled off and thus broken, a problem may be caused not to function as an antenna.

### DISCLOSURE

### Technical Problem

To solve the above problems or defects, it is an object of the present invention to provide a protective cover for a portable terminal capable of shielding electromagnetic waves generated in a portable terminal, in which the protective cover has a conductive metal layer on an inner surface of a cover layer.

It is another object of the present invention to provide a protective cover for a portable terminal capable of performing an antibacterial function in addition to shielding of electromagnetic waves in which the protective cover has a silver yarn or a silver ply yarn on an inner surface of a cover layer.

It is still another object of the present invention to provide a protective cover for a portable terminal that makes it easy to use the portable terminal and that is capable of further slimming the portable terminal, without using an external antenna in the portable terminal by forming a metal layer on an inner surface of a cover layer in an antenna pattern to thus be used for a DMB receiving purpose.

It is yet another object of the present invention to provide a protective cover for a portable terminal capable of improving antenna performance, and preventing a metal yarn from being modified or cut off, to thus prevent a break of an antenna pattern, by making a conductive ply yarn by using a metal yarn made of a conductive metal.

It is yet still another object of the present invention to provide a protective cover for a portable terminal capable of shielding electromagnetic waves generated in a portable terminal, performing an antibacterial function, smoothening blood circulation, and promoting health by emitting a far-infrared radiation, and a method of manufacturing the same.

It is a further object of the present invention to provide a protective cover for a portable terminal and a method of manufacturing the same, in which a pigment is added in a spinning solution, to thereby prevent an oxidation phenomenon of Ag from being externally exposed to thus make a beautiful design.

It is a still further object of the present invention to provide a protective cover for a portable terminal and a method of manufacturing the same, in which a conductive metal plate is attached on a cover layer, to thereby shield electromagnetic waves, and a spinning solution containing an Ag-nanomaterial is electrospun on the conductive metal plate to thus form an Ag-nanoweb layer to thereby perform an antibacterial function.

### Technical Solution

To accomplish the above and other objects of the present invention, according to an aspect of the present invention, there is provided a protective cover for a portable terminal, the protective cover comprising: a cover layer; an adhesive layer that is laminated on an inner surface of the cover layer; and a metal layer that is attached on the adhesive layer to perform an electromagnetic wave shielding function.

Preferably but not necessarily, the metal layer is made of a conductive metal thin film or in the form of wires, in which the wires are arranged to be perpendicular to each other in a mesh form.

Preferably but not necessarily, the metal layer is made of pure silver or a silver alloy to have an antibacterial function.

Preferably but not necessarily, the metal layer is made of a double metal yarn, wherein the double metal yarn comprises: a central metal layer whose strength is higher than silver (Ag) and whose elongation is equal to or higher than Ag; and an Ag layer that is surrounded on an outer surface of the central metal layer.

Preferably but not necessarily, the metal layer is formed of a conductive ply yarn, the conductive ply yarn comprises: a first fiber yarn formed of synthetic or natural fibers; a metal yarn that is wound in a spiral form on an outer circumferential surface of the first fiber yarn, and has antibacterial property and conductivity; and at least one strand of a second fiber yarn that is plied with the first fiber yarn on which at least one strand of the metal yarn is wound.

According to another aspect of the present invention, there is provided a protective cover for a portable terminal, the protective cover comprising: a cover layer of made of a resin material; an adhesive layer that is laminated on an inner surface of the cover layer; a metal layer that is attached on the adhesive layer to perform an electromagnetic wave shielding function; and a fiber layer that is laminated on the metal layer to protect the metal layer.

According to still another aspect of the present invention, there is provided a protective cover for a portable terminal, the protective cover comprising: a cover layer; and an Ag-nanoweb layer that is laminated on an inner surface of the cover layer and that is formed by electrospinning a spinning solution containing an Ag-nanomaterial.

Preferably but not necessarily, the spinning solution is formed of the Ag-nanomaterial, a polymer material that can be electrospun, and a solvent that are mixed at a predetermined ratio.

Preferably but not necessarily, the spinning solution further comprises a pigment to prevent an oxidation phenomenon of Ag from being externally exposed.

Preferably but not necessarily, the conductive metal layer is formed of a conductive metal plate, or in the form of wires, in which the wires are arranged to be perpendicular to each other in a mesh form.

According to yet another aspect of the present invention, there is provided a method of manufacturing a protective cover for a portable terminal, the method comprising the steps of: preparing a cover layer; and electrospinning a spinning solution containing an Ag-nanomaterial to thus form an Ag-nanoweb layer laminated on an inner surface of the cover layer.

### Advantageous Effects

As described above, a protective cover for a portable terminal according to the present invention includes a conductive metal layer on an inner surface of a cover layer to thus be capable of shielding electromagnetic waves generated in a portable terminal.

In addition, the protective cover for a portable terminal according to the present invention includes a silver yarn or a silver ply yarn on an inner surface of a cover layer to thus be capable of performing an antibacterial function.

In addition, the protective cover for a portable terminal according to the present invention includes forms a metal layer on an inner surface of a cover layer in an antenna pattern to thus be used for a DMB receiving purpose, to thereby make it easy to use the portable terminal and be capable of further slimming the portable terminal, without using an external antenna in the portable terminal.

In addition, the protective cover for a portable terminal according to the present invention is capable of improving antenna performance, and preventing a metal yarn from being modified or cut off, to thus prevent a break of an antenna pattern, by making a direction of a primary process that winds a metal yarn on a fiber yarn and a direction of a secondary process that plies a ply yarn and another ply yarn or a ply yarn and a fiber yarn equal each other when making a conductive ply yarn, to thereby make a structure that the metal yarn is inserted into the fiber yarn.

In addition, the protective cover for a portable terminal according to the present invention is formed by electrospinning a spinning solution containing an Ag-nanomaterial on a conductive metal plate to thus form an Ag-nanoweb layer, to thus be capable of shielding electromagnetic waves generated in a portable terminal, performing an antibacterial function of removing various microbes contaminating the portable terminal, smoothening blood circulation, and promoting health by emitting a far-infrared radiation.

In addition, the protective cover for a portable terminal according to the present invention is formed by adding a pigment in a spinning solution, to thereby prevent an oxidation phenomenon of Ag from being externally exposed to thus make a beautiful design.

In addition, the protective cover for a portable terminal according to the present invention is formed by attaching a conductive metal plate on a cover layer, to thereby shield electromagnetic waves, and electrospinning a spinning solution containing an Ag-nanomaterial on the conductive metal plate to thus form an Ag-nanoweb layer to thereby improve an electromagnetic wave shielding function as well as perform an antibacterial function.

### DESCRIPTION OF DRAWINGS

FIG. 1 is a perspective view of a portable terminal equipped with a protective cover according to a first embodiment of the present invention.

FIG. 2 is a cross-sectional view of a protective cover according to an embodiment of the present invention.

FIG. 3 is a plan view of a metal layer according to an embodiment of the present invention.

FIG. 4 is a plan view of an antenna pattern formed on a metal layer in accordance with an embodiment of the present invention.

FIG. 5 is a plan view of an antenna pattern formed on a metal layer in accordance with another embodiment of the present invention.

FIG. 6 is a cross-sectional view of a double metal yarn used as a metal layer in accordance with one embodiment of the present invention.

FIG. 7 is a side view of a conductive ply yarn used as a metal layer according to an embodiment of the present invention.

FIGS. 8 and 9 are diagrams showing a process of manufacturing a conductive ply yarn according to an embodiment of the present invention.

FIG. 10 is a cross-sectional view of a protective cover according to a second embodiment of the present invention.

FIG. 11 is a cross-sectional view illustrating a state where a fiber layer and a metal layer of a protective cover are integrally woven to form a one-body according to a second embodiment of the present invention.

FIG. 12 is a cross-sectional view of a protective cover according to a third embodiment of the present invention.

FIG. 13 is a cross-sectional view of a protective cover according to a fourth embodiment of the present invention.

FIG. 14 is a plan view of a mesh-type metal layer according to the fourth embodiment of the present invention.

FIG. 15 is a block diagram of an electrospinning apparatus for forming an Ag-nanoweb layer according to the present invention.

FIGS. 16A and 16B are photos that are obtained by photographing culture conditions to carry out an antibacterial test by inoculating Staphylococcus aureus into a culture medium with an Ag-nanoweb layer or a culture medium without an Ag-nanoweb layer, according to the third and fourth embodiments of the present invention.

FIGS. 17A and 17B are photos that are obtained by photographing culture conditions to carry out an antibacterial test by inoculating Klebsiella pneumonia into a culture medium with an Ag-nanoweb layer or a culture medium without an Ag-nanoweb layer, according to the third and fourth embodiments of the present invention.

### BEST MODE

The above and other objects, features, and advantages of the present invention can be appreciated by the following description and will be understood more clearly by embodiment of the present invention. In addition, it will be appreciated that the objects and advantages of the present invention will be easily realized by means shown in the appended patent claims, and combinations thereof. Accordingly, the technical spirit of the present invention can be easily implemented by one of ordinary skill in the art.

Further, if it is determined that the detailed description of the known art related to the present invention makes the gist of the present invention unnecessarily obscure, a detailed description thereof will be omitted.

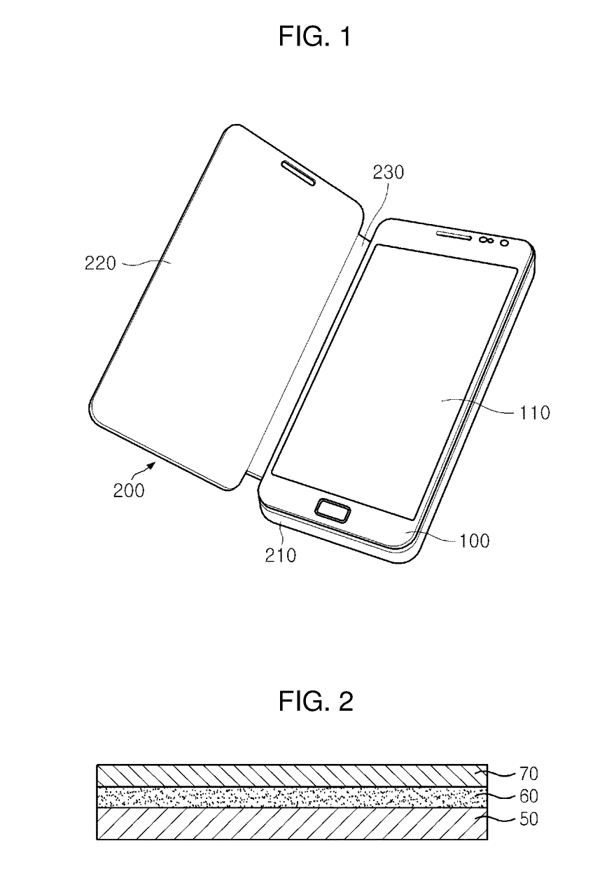

FIG. 1 is a perspective view of a portable terminal equipped with a protective cover according to a first embodiment of the present invention. FIG. 2 is a cross-sectional view of a protective cover according to an embodiment of the present invention.

Referring to FIG. 1, a portable terminal in accordance with an exemplary embodiment of the present invention includes: a terminal main body 100 on the front surface of which a display window 110 and a touch panel are mounted; and a protective cover 200 having an opening and closing structure that is mounted to cover the outer surface of the terminal main body 100 and to open the display window 110.

The portable terminal described in the present embodiment may include any portable electronic devices such as a mobile phone, a smart phone, a laptop computer (a notebook computer), a digital broadcasting terminal, PDA (Personal Digital Assistants), PMP (Portable Multimedia Players), and navigation devices.

The protective cover 200 includes: a fixing unit 210 which is coupled to the rear surface of the portable terminal 100; a cover unit 220 that is extended from the fixing unit 210 so as to cover the front surface of the portable terminal 100; and a connecting unit 230 that connects between the fixing unit 210 and the cover unit 220.

As shown in FIG. 2, the protective cover 200 includes: a cover layer 50 to maintain the strength of the protective cover 200; an adhesive layer 60 that is attached on an inner surface of the cover layer 50; and a metal layer 70 that is attached on the adhesive layer 60 and formed of a conductive metal capable of shielding electromagnetic waves.

Here, the metal layer 70 is made of an electrically conductive metal such as Ni, Cu, and Al, and alloys thereof, which has an excellent electrical conductivity.

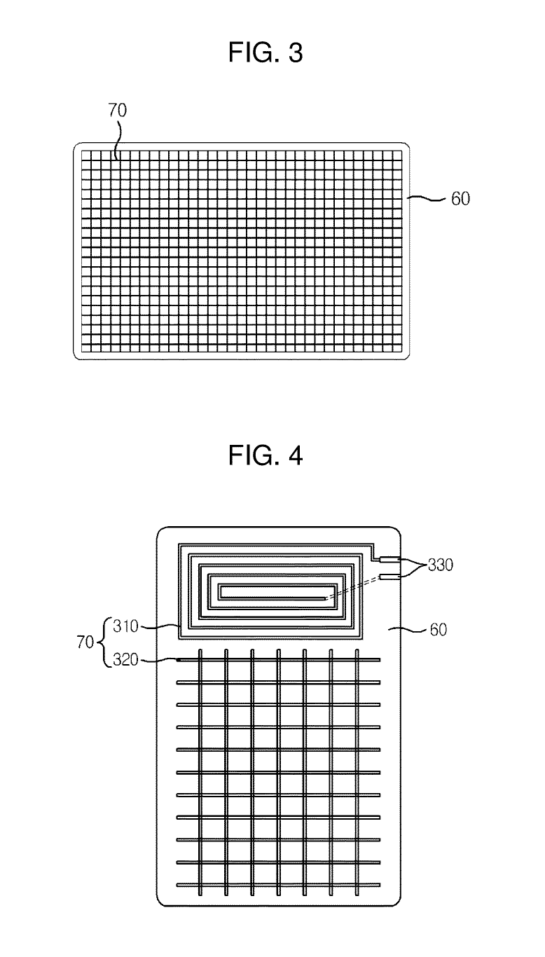

The metal layer 70 may be formed of a conductive metal thin film, or the metal layer 70 is made in the form of conductive metal thin wires, in which the conductive metal thin wires are arranged to be perpendicular to each other in a mesh form, so as to be bonded on the adhesive layer 60, as shown in FIG. 3.

In addition, the metal layer 70 may include a silver yarn that is obtained by manufacturing pure silver (Ag) or a silver alloy containing Ag having conductivity in the form of wires to impart antibacterial performance. That is, the silver (Ag) or the Ag alloy is manufactured of a wire form by a drawing process and then the wires are arranged to be perpendicular to each other in a mesh form. When the metal layer 70 is formed by using the silver (Ag) or the Ag alloy, the antibacterial properties and the electromagnetic wave shielding performance as the specific properties of Ag may be available.

In another embodiment of the present embodiment, the metal layer 70 may be formed in an antenna pattern, when the metal layer 70 plays a role of a DMB receiving antenna.

That is, as shown in FIG. 4, the metal layer 70 includes: an antenna unit 310 that is formed to have a pattern shape of the same antenna pattern as that of a DMB antenna; and an electromagnetic wave shielding unit 320 that is arranged at a predetermined interval at the lower side of the antenna unit 310, to thus perform an antibacterial function and an electromagnetic wave shielding function.

Connecting terminals 330 that are electrically connected to the portable terminal are respectively formed at both ends of the antenna unit 310. A connection structure of the connecting terminals 330 is achieved by inserting connectors that are formed in the connecting terminals 330 of the antenna unit 310 into sockets provided in the portable terminal 100. In some embodiments, the connecting terminals may have a structure of being integrally connected to the portable terminal in the process of manufacturing the portable terminal. Further, the connecting terminals may adopt a variety of connection structures.

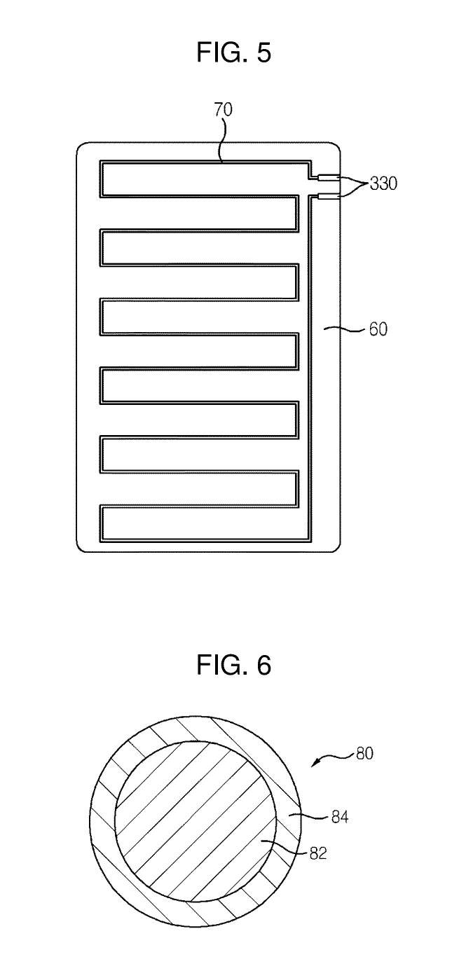

In addition, as shown in FIG. 5, the metal layer 70 according to another embodiment is formed in an antenna pattern over the entire surface of the cover layer 50 thereby maximizing the size of the antenna and providing a structure of improving the reception performance. The antenna pattern may be achieved in various forms, depending on the reception capability of the portable terminal.

In addition, the conductive ply yarn according to another embodiment is formed in an antenna pattern over the entire surface of the fiber layer thereby performing an antibacterial function and an electromagnetic wave shielding function at the same time.

In addition, as shown in FIG. 6, the metal layer according to another embodiment is formed of a double metal yarn 80 having a double structure to enhance the strength and to reduce the manufacturing cost. That is, the double metal yarn 80 includes: a central metal layer 82 whose strength is higher than silver (Ag) and whose elongation is similar to or equal to or higher than Ag; and an Ag layer 84 that is surrounded on an outer surface of the central metal layer 82.

Here, the central metal layer 82 may include Cu or a Cu—Zn alloy having conductivity.

Thus, the double metal yarn 80 is arranged orthogonally to each other in a mesh form and attached on the cover layer 50 by the adhesive layer 60. The double metal yarn 80 may impart an antibacterial performance of specific properties of Ag, to thus carry out antibacterial properties as well as an electromagnetic wave shielding function.

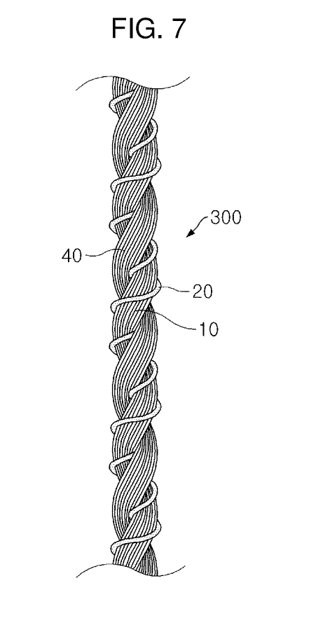

In addition, the metal layer 70 may be made of a conductive ply yarn 300. That is, as illustrated in FIG. 7, the conductive ply yarn 300 includes: a first fiber yarn 10; a metal yarn 20 that is wound in a spiral form on an outer circumferential surface of the first fiber yarn 10 having an antibacterial performance and conductivity; and at least one strand of a second fiber yarn 40 that is plied with the first fiber yarn 10 on which at least one strand of the metal yarn 20 is wound.

Here, the metal yarn 20 may be formed of a conductive metal such as aluminum or copper in the case of having the electromagnetic wave shielding performance, and may be formed of Ag or an Ag alloy so as to have antibacterial performance in the case of further performing an antibacterial function in addition to the electromagnetic wave shielding performance.

The conductive ply yarn according to this embodiment has a structure capable of preventing a phenomenon that the metal yarn 20 is deformed or broken.

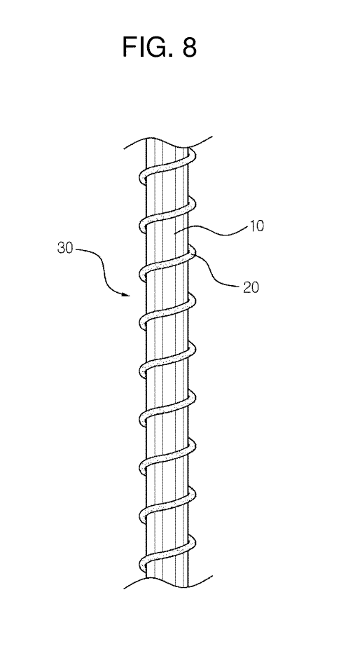

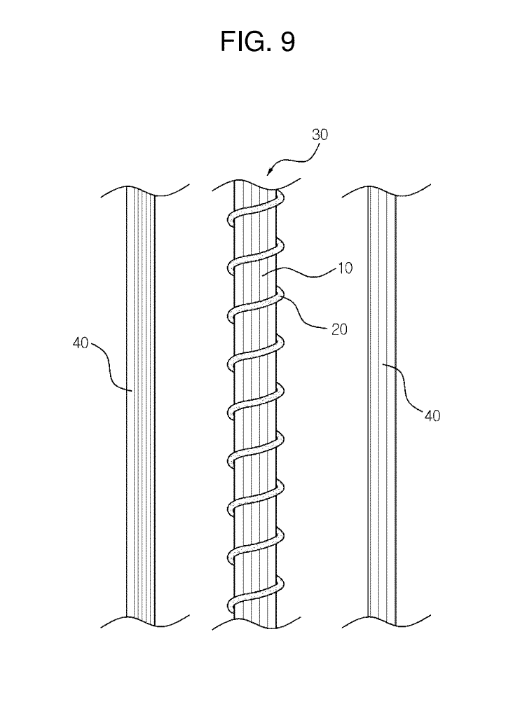

A process of manufacturing a conductive ply yarn according to the embodiment as constructed above includes: a first process of making a primary ply yarn 30 by winding the metal yarn 20 in one direction on an outer circumferential surface of the first fiber yarn 10 used as a covered yarn so as to be the number of twists per meter TIM, as shown in FIGS. 8 and 9; and a second process of making a secondary ply yarn 40 by twisting one or more strands of the primary ply yarn 30 and one or more strands of the second fiber yarn 40.

The first fiber yarn 10 and the second fiber yarn 40 may employ any of natural fibers or synthetic fibers having a sufficient strength as a sewing thread.

The natural fibers include a fiber made of any one of, for example, Korean paper, PLA (polylactic acid), cotton, linen, and wool.

The synthetic fibers include a fiber made of any one of, for example, nylon, polyester-based, polyvinyl chloride-based, polyacrylonitrile-based, polyamide-based, polyolefin-based, polyurethane-based, polyfluoreethylene-based fibers.

In addition, the synthetic fibers may use a fiber obtained by using the following polymers:
polyethylene-based resins, for example, low-density polyethylene (LDPE) resins, linear low-density polyethylene (LLDPE) resins, high-density polyethylene (HDPE) resins, ethylene-vinyl acetate (EVA) resins, and copolymers thereof, etc.;
polystyrene-based resins, for example, HIPS, GPPS, SAN, etc.;
polypropylene-based resins, for example, HOMO PP, RANDOM PP, and copolymers thereof;
transparent or plain ABS (acrylonitrile-butadiene-styrene) terpolymer;
Rigid PVC;
engineering plastics, for example, nylon, PRT, PET, POM (polyacetal), PC, urethane, powder resins, PMMA, PES, etc.

In addition, the first fiber yarn 10 and the second fiber yarn 40 may adopt any fiber yarn that may be used as a covered yarn in addition to the natural fibers or synthetic fibers described above.

The metal yarn 20 may adopt a conductive metal such as pure silver (Ag), an Ag alloy containing Ag and having the antibacterial properties and a conductivity, aluminum, copper, etc.

When the metal yarn 20 is wound on the outer circumferential surface of the first fiber yarn 10, the number of twists per meter (T/M) of the metal yarn 20 is higher than a predetermined formula twist number (T/M), and is wound on the outer circumferential surface of the first fiber yarn 10 in the same spiral shape as a coil spring.

In one example, the twist number (T/M) of the metal yarn 20 is set to be in a range of 600˜1500 T/M to have a high twist number.

When the conductive ply yarn manufacturing process proceeds in the same direction as the direction of winding the metal yarn 20 of the primary ply yarn 30 made in the first process and the direction of twisting the primary ply yarn 30 made in the first process and the second fiber yarn 40, the metal yarn 20 is inserted into the second fiber yarn 40 and thus the metal yarn 20 does not protrude to the outside of the second fiber yarn 40.

In other words, the conductive ply yarn according to the embodiment of the present invention is formed by winding the metal yarn 20 having the number of twists per meter (T/M) of a set value or more on the outer circumferential surface of the first fiber yarn 10 in a spiral form such as a coil spring in the first process. Accordingly, when the first fiber yarn 10 is extended and compressed, the metal yarn 20 is released and shrunk in the same function as the coil spring, to thus prevent the metal yarn 20 from being deformed.

In addition, since at least one ply yarn 30 and at least one second fiber yarn 40 are plied and wound in the same direction as the winding direction of the metal yarn 20 in the second process, the metal yarn 20 is inserted into the second fiber yarn 40 and thus the metal yarn 20 does not protrude to the outside of the second fiber yarn 40.

Therefore, the metal yarn into the fiber yarn may be prevented from being deformed due to the required strength and the repeated reciprocating movement when the conductive ply yarn with the metal yarn inserted according to the embodiment of the present invention is integrally woven or sewed on the fiber layer.

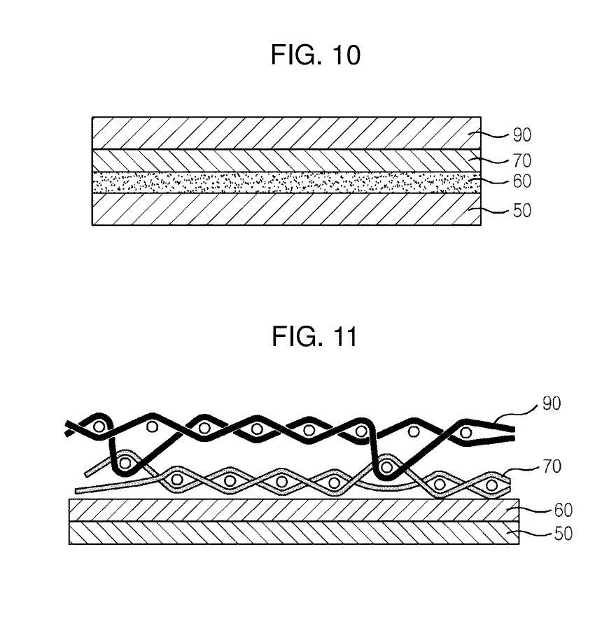

FIG. 10 is a cross-sectional view of a protective cover according to a second embodiment of the present invention. FIG. 11 is a cross-sectional view illustrating a state where a fiber layer and a metal layer of a protective cover are integrally woven to form a one-body according to a second embodiment of the present invention.

Referring to FIG. 10, a protective cover according to a second embodiment of the present invention includes: a cover layer 50 which maintains the strength of the protective cover; an adhesive layer 60 attached on an inner surface of the cover layer 50; a metal layer 70 adhered to the adhesive layer 60 and made of an electromagnetic wave shielding conductive metal material; and a fiber layer 90 that is laminated on the metal layer 70 to protect the metal layer 70 and maintain the soft texture.

Here, the metal layer may be formed of any type of a conductive metal thin film and a conductive metal in a mesh form as described above, or may be formed of a silver yarn that is formed by manufacturing pure silver or a silver alloy containing silver in the form of wires. Otherwise, the metal layer may be formed of a double structure silver yarn or conductive ply yarn.

Here, when the silver yarn or conductive ply yarn is used as the metal layer, the metal layer can be woven with the fiber layer. That is, as shown in FIG. 11, a double structure is formed so that the metal layer is woven at the lower portion of the fiber layer when the fiber layer is woven.

In this way, when the fiber layer and the metal layer are woven together, the metal layer may be exposed between the fiber layer and the fiber layer, to thus be suitable for performing an antibacterial function and to thus simplify the manufacturing process.

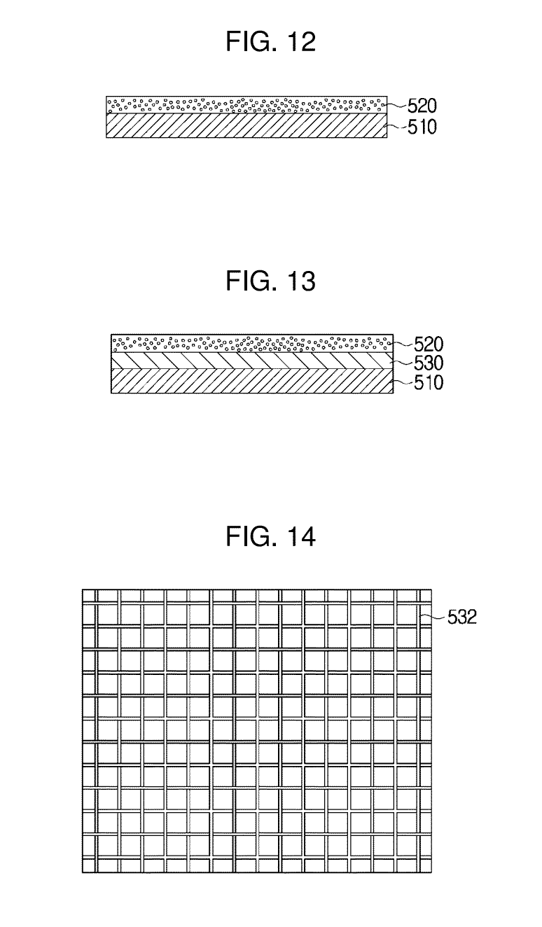

FIG. 12 is a cross-sectional view of a protective cover according to a third embodiment of the present invention. FIG. 13 is a cross-sectional view of a protective cover according to a fourth embodiment of the present invention. FIG. 14 is a plan view of a mesh-type metal layer according to the fourth embodiment of the present invention.

Referring to FIG. 12, the protective cover according to the third embodiment of the present invention includes: a cover layer 510 to maintain the strength of the protective cover; and an Ag-nanoweb layer 520 that is formed by electrospinning a spinning solution containing an Ag-nanomaterial on an inner surface of the cover layer 510.

Here, the Ag-nanoweb layer 520 contains the Ag-nanomaterial to thus perform an antibacterial function as well as an electromagnetic wave shielding function.

The Ag-nanomaterial may employ various solid-state Ag-nanomaterials including a silver metal salt such as silver nitrate (AgNO₃), silver sulfate (Ag₂SO₄), silver chloride (AgCl) and the like including powder forms.

The Ag-nanoweb layer 520 according to this embodiment is formed by electrospinning a spinning solution containing an Ag-nanomaterial to thus create ultra-fine fiber strands, and accumulating the ultra-fine fiber strands in a predetermined thickness to thereby form a nanoweb.

Here, the spinning method that is applied for the present invention may employ any one of general electrospinning, air-electrospinning (AES), electrospray, electrobrown spinning, centrifugal electrospinning, and flash-electrospinning.

In other words, any of spinning methods of making ultrafine fiber strands in an accumulated form can be also applied to the Ag-nanoweb layer 520 according to the present invention.

The spinning solution is formed by mixing an Ag-nanomaterial, a polymer material that can be electrospun, and a solvent at a predetermined mixture ratio. Here, silver nitrate (AgNO₃) is preferably used as the Ag-nanomaterial.

In addition, Ag is attached to the inner surface of the cover layer 510 and exposed externally, and thus there is a fear that the color by oxidation of Ag may change. When a pigment is added in a spinning solution to prevent the color by oxidation of Ag from changing, oxidation of Ag is not exposed and a beautiful design of the protective cover is also made.

Here, the color of the pigment may be black or gray. Otherwise, a variety of different colors may be used to ensure that no Ag oxidation is seen.

Here, the polymer materials that can be electrospun in the present invention may include: polyvinylidene fluoride (PVdF), poly(vinylidene fluoride-co-hexafluoropropylene), a perfluoropolymer, polyvinyl chloride, polyvinylidene chloride, or a copolymer thereof; a polyethylene glycol derivative containing polyethylene glycol dialkylether and polyethylene glycol dialkylester; poly(oxymethylene-oligo-oxyethylene); polyoxide containing polyethylene oxide and polypropylene oxide; polyvinyl acetate, poly(vinyl pyrrolidone-vinyl acetate), polystyrene, and a polystyrene acrylonitrile copolymer; a polyacrylonitrile copolymer containing polyacrylonitrile (PAN) and a polyacrylonitrile methyl methacrylate copolymer; or polymethyl methacrylate, a poly methyl methacrylate copolymer, or a mixture thereof.

Thus, since the Ag-nanoweb layer 520 according to the present embodiment is formed on the surface of the cover layer by the electrospinning method, the Ag-nanoweb layer 520 can be made in a variety of thicknesses depending on the dose of the spinning solution, to thus show an advantage of providing a good contact feeling due to a smooth surface.

In addition, an Ag layer for performing an electromagnetic wave shielding function and an antibacterial function is formed by using the electrospinning method, to thus enable an easy production, and prevent the Ag layer from being separated, and manufacture the Ag layer with a wide range of thicknesses.

A protective cover for a portable terminal according to a fourth embodiment as shown in FIG. 13, includes a cover layer 510 for holding the strength of the protective cover; a metal layer 530 that is attached on an inner surface of the cover layer 510, and that performs an electromagnetic wave shielding function; and an Ag-nanoweb layer 520 that is formed by electrospinning a spinning solution containing an Ag-nanomaterial on the metal layer 530.

Here, the metal layer 530 is made of an electrically conductive metal such as Ni, Cu, and Al, and alloys thereof, which has an excellent electrical conductivity.

The metal layer 530 may be formed of a conductive metal thin film, or is made in the form of conductive metal thin wires 532, in which the conductive metal thin wires 532 are arranged to be perpendicular to each other in a mesh form, as shown in FIG. 14.

Then, the metal layer 530 may have a sterling silver or silver containing a gift of mesh and arranged to be orthogonal to produce the alloy in wire form can be used.

A metal layer 530 and the Ag-nanoweb layer 520 may be produced separately from each other and manufactured by a laminating process in a subsequent process. Otherwise, the Ag-nanoweb layer 520 may be directly electrospun on the surface of the metal layer 530.

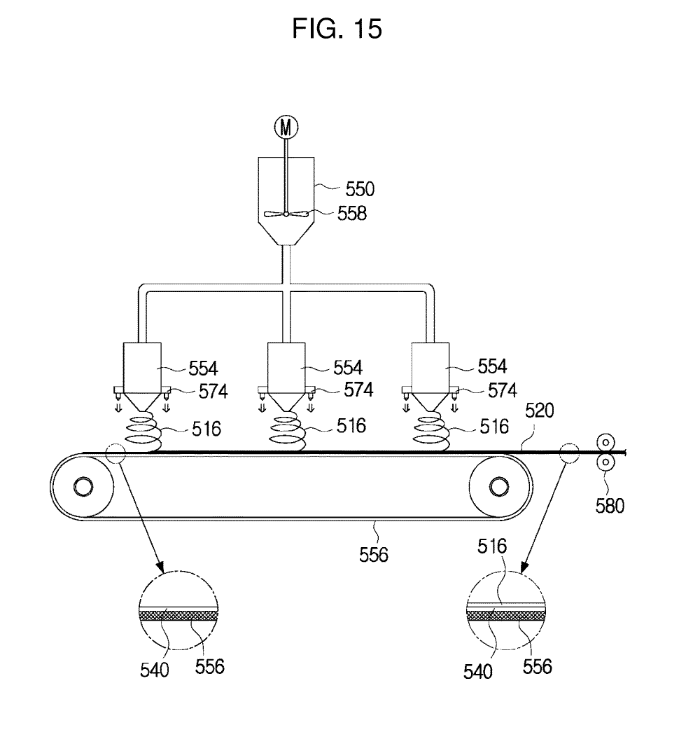

FIG. 15 is a block diagram showing an electrospinning apparatus for forming an Ag-nanoweb layer according to the present embodiment.

The electrospinning apparatus according to the present embodiment includes: a mixing tank 550 storing a spinning solution that is formed by mixing an Ag-nanomaterial, a polymer material and a solvent at a predetermined ratio; spinning nozzles 554 that are connected to a high voltage generator and the mixing tank 550, to thus spin ultra-fine nanofibers; and a collector 556 that is positioned below the spinning nozzles 554 and that is movably mounted in the front and rear direction and left and right direction, to thus collect the ultrafine nanofibers spun from the spinning nozzles 554 and form an Ag-nanoweb layer 520 having a predetermined thickness.

The mixing tank 550 is provided with an agitator 558 that evenly mixes the Ag-nanomaterial, the polymer material and the solvent and maintains a constant viscosity of the spinning solution.

A high voltage electrostatic force of 90 to 120 Kv is applied between the collector 556 and each of the spinning nozzles 554, to thereby enable the spinning nozzles 554 to spin ultrafine fiber strands 516, and to thus enable the ultrafine fiber strands 516 to be accumulated on the collector 556 to thereby form an Ag-nanoweb layer 520.

The spinning nozzles 554 are provided with an air spray apparatus 574, respectively, to thereby prevent the ultrafine fiber strands 516 spun from the spinning nozzles 554, from fluttering without being smoothly collected to the collector 556.

The multi-hole spin pack nozzles used in the present invention are made to set an air pressure of air spraying to be in the range of about 0.1 to about 0.6 MPa. In this case, the air pressure that is less than about 0.1 MPa, does not contribute to capture and integrate the ultrafine fiber strands. In the case that the air pressure exceeds about 0.6 MPa, the cone of each spinning nozzle is hardened to thus cause a clogging phenomenon of the needle to occur and to thereby cause a spinning trouble to occur.

When only the Ag-nanoweb layer 520 is formed on the collector 556, a release film 540 is arranged. When the ultrafine fiber strands are directly spun on an inner surface of the cover layer, the cover layer is arranged. When the ultrafine fiber strands are directly spun on an inner surface of the metal layer, the metal layer is arranged.

That is, as in the third embodiment of the present invention, in the case of directly forming the Ag-nanoweb layer 520 on the inner surface of the cover layer, the cover layer is placed on the top surface of the collector 556 and then the ultrafine fiber strands are spun and accumulated on the inner surface of the cover layer from the spinning nozzles, to thereby form an Ag-nanoweb layer 520 having a predetermined thickness.

Then, as in the fourth embodiment of the present invention, when the metal layer is attached to the cover layer, the metal layer is disposed on the top surface of the collector and the ultrafine fiber strands are spun and accumulated on the inner surface of the metal layer from the spinning nozzles, to thereby form an Ag-nanoweb layer 520 having a predetermined thickness.

In addition, after preparing the metal layer and the Ag-nanoweb layer 520 separately, when the metal layer and the Ag-nanoweb layer 520 are laminated to each other, a release film is placed on the upper surface of the collector and then the ultrafine fiber strands are spun and accumulated on the surface of the release film from the spinning nozzles, to thereby form an Ag-nanoweb layer 520 having a predetermined thickness.

Here, as described above, the metal layer may employ a conductive metal plate, or a conductive metal sheet in a mesh form. Otherwise, the metal layer may employ a silver yarn that is formed in a mesh form by using an Ag wire.

A pressure roller 580 that pressurizes (or calenders) the Ag-nanoweb layer 520 to have a constant thickness is provided at a rear side of the collector 556.

A process for producing an Ag-nanoweb layer by using an electrospinning apparatus as described above will be described as follows.

First, when the collector 556 is driven, a table is moved in the longitudinal direction or longitudinal/lateral direction. In addition, a high voltage electrostatic force of 90 to 120 Kv is applied between the collector 556 and each of the spinning nozzles 554, to thereby make the spinning solution spun from the spinning nozzles 554 into the ultrafine fiber strands 516 to then be spun onto the collector 556.

The ultrafine fiber strands 516 are accumulated on the collector to thus form the Ag-nanoweb layer 520.

In this case, when the fiber strands are spun by air spray apparatuses 574 located at the spinning nozzles 554, air is sprayed onto the ultrafine fiber strands 516 so that the fiber strands 516 can be collected and captured on the collector 556 without fluttering.

Here, any one of the release film, the cover layer and the metal layer is disposed on the collector, and thus the Ag-nanoweb layer 520 is formed on the release film, the Ag-nanoweb layer 520 is formed on the cover layer, or the Ag-nanoweb layer 520 is formed on the metal layer.

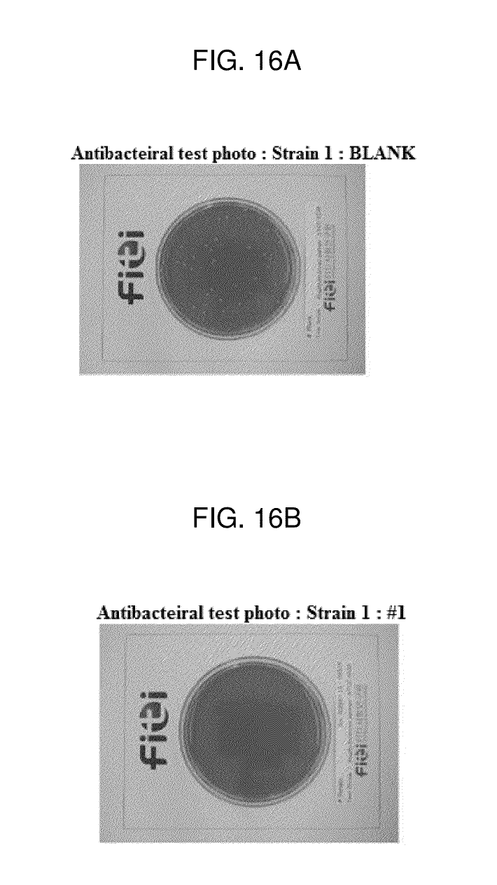

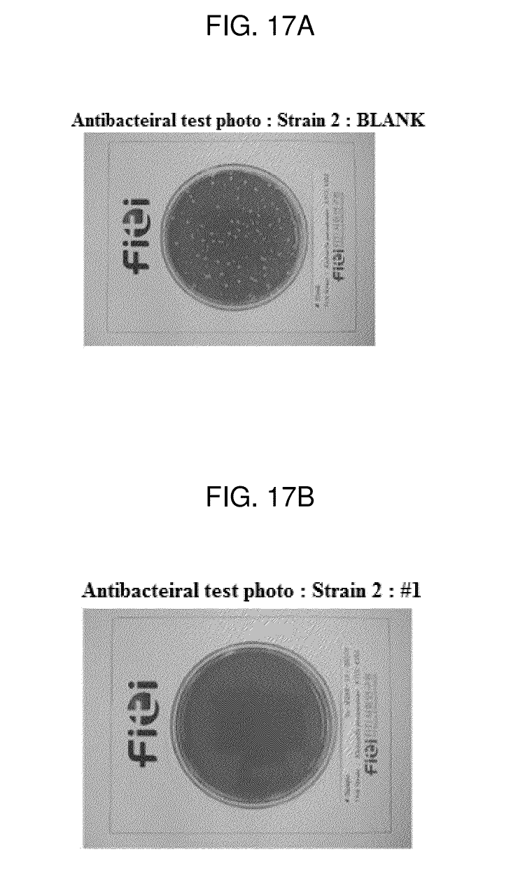

FIGS. 16A and 16B are photos that are obtained by photographing culture conditions to carry out an antibacterial test by inoculating Staphylococcus aureus into a culture medium with an Ag-nanoweb layer or a culture medium without an Ag-nanoweb layer, according to the third and fourth embodiments of the present invention. FIGS. 17A and 17B are photos that are obtained by photographing culture conditions to carry out an antibacterial test by inoculating Klebsiella pneumonia into a culture medium with an Ag-nanoweb layer or a culture medium without an Ag-nanoweb layer, according to the third and fourth embodiments of the present invention.

In order to test an antibacterial activity of an Ag-nanoweb layer applied to the third and fourth embodiments of the present invention, at first, a polyacrylonitrile (PAN) polymer and silver nitrate (AgNO₃) with purity of 99.999% as a first class reagent is mixed and the mixture is dissolved in a solvent of DMAc at a ratio of 12 wt %, to thus prepare a spinning solution. In this case, the content of silver nitrate was configured to be at a ratio of 5 wt % with respect to the PAN.

Thereafter, the prepared spinning solution is fed to the spinning nozzle pack and then is electrospun in the spinning atmosphere of 30° C., relative humidity of 60%, so that a discharge rate per minute becomes 0.05 cc/ghole at an applied voltage of 25 kV, with the distance of 20 cm between the spinning nozzle and the collector, to thereby obtain an Ag-nanoweb layer.

In this way, the prepared Ag-nanoweb layer is formed by laminating the PAN nanofibers containing the silver nitrate of 5 wt %, and an antibacterial test for the prepared Ag-nanoweb layer was performed by the method according to Test Standard KS K 0693-2001, in order to evaluate an antibacterial activity. Strains used are Staphylcoccus aureus (ATCC 6538) (strain 1) that is the major cause of food poisoning and Klebsiella pneumoniae (ATCC 4352) (strain 2) that are pneumoniae bacteria, which were inoculated on a nonionic surfactant activator (Snogen) of 0.05% and cultured for 24 hours at 37° C., to then be used as the inoculum. In the test score results from FITI (Friend of Industry Technology Information) Testing Institute, the strain inoculated and cultured into a culture medium (#1) with the Ag-nanoweb layer applied in the present invention has a reduction rate of 99.9% in bacteriostatic culture in comparison with the strain inoculated and cultured into a culture medium (BLANK) with no Ag-nanoweb layer, to thus exhibit a remarkably excellent antibacterial effect.

In other words, it can be seen that the cultured strain of the culture medium (#1) with the Ag-nanoweb layer of FIGS. 16B and 17B is significantly reduced when compared with the cultured strain of the culture medium (BLANK) with no Ag-nanoweb layer of FIGS. 16A and 17A.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The present invention provides a protective cover for a portable terminal having an electromagnetic wave shielding, anti-bacterial or DMB receiving antenna function.

1. A protective cover for a portable terminal, the protective cover comprising:
a cover layer;
an adhesive layer that is laminated on an inner surface of the cover layer; and
a metal layer that is attached on the adhesive layer to perform an electromagnetic wave shielding function.

2. The protective cover according to claim 1, wherein the metal layer is made of a conductive metal thin film.

3. The protective cover according to claim 1, wherein the metal layer is made in the form of wires, and the wires are arranged to be perpendicular to each other in a mesh form.

4. The protective cover according to claim 1, wherein the metal layer is made of pure silver or a silver alloy to have an antibacterial function.

5. The protective cover according to claim 1, wherein the metal layer is made of a double metal yarn, wherein the double metal yarn comprises:
a central metal layer whose strength is higher than silver (Ag) and whose elongation is equal to or higher than Ag; and
an Ag layer that is surrounded on an outer surface of the central metal layer.

6. The protective cover according to claim 1, wherein the metal layer is formed of a conductive ply yarn, the conductive ply yarn comprises:
a first fiber yarn formed of synthetic or natural fibers;
a metal yarn that is wound in a spiral form on an outer circumferential surface of the first fiber yarn, and has antibacterial property and conductivity; and
at least one strand of a second fiber yarn that is plied with the first fiber yarn on which at least one strand of the metal yarn is wound.

7. The protective cover according to claim 6, wherein the metal yarn is formed of pure silver, an Ag alloy, or other conductive metal.

8. The protective cover according to claim 1, wherein the metal layer is formed in a DMB (Digital Multimedia Broadcasting) receiving antenna pattern to perform a DMB reception antenna function.

9. The protective cover according to claim 8, wherein connection terminals are formed at both ends of the antenna pattern, and the connection terminals are electrically connected to the portable terminal.

10. The protective cover according to claim 1, further comprising a fiber layer that is laminated on the metal layer to protect the metal layer.

11. The protective cover according to claim 10, wherein the metal layer is formed of any one of a silver yarn, a conductive ply yarn, and a double metal yarn, and is woven at a lower side of the fiber layer when weaving the fiber layer.

12. A protective cover for a portable terminal, the protective cover comprising:
a cover layer; and
an Ag-nanoweb layer that is laminated on an inner surface of the cover layer and that is formed by electrospinning a spinning solution containing an Ag-nanomaterial.

13. The protective cover according to claim 12, wherein the spinning solution is formed of the Ag-nanomaterial, a polymer material that can be electrospun, and a solvent that are mixed at a predetermined ratio.

14. The protective cover according to claim 12, wherein the spinning solution further comprises a pigment to prevent an oxidation phenomenon of Ag from being externally exposed.

15. The protective cover according to claim 12, further comprising a conductive metal layer to be laminated on an inner surface of the cover layer, wherein the spinning solution containing the Ag-nanomaterial is electrospun on the conductive metal layer so that the Ag-nanoweb layer is laminated on the conductive metal layer.

16. The protective cover according to claim 15, wherein the conductive metal layer is formed of a conductive metal plate.

17. The protective cover according to claim 15, wherein the conductive metal layer is made in the form of wires, and the wires are arranged to be perpendicular to each other in a mesh form.

18. The protective cover according to claim 15, wherein the conductive metal layer is formed of a silver yarn that is made by making pure silver or a silver alloy containing silver in the form of wires in which the wires are arranged to be perpendicular to each other in a mesh form.

19. A method of manufacturing a protective cover for a portable terminal, the method comprising the steps of:
preparing a cover layer; and
electrospinning a spinning solution containing an Ag-nanomaterial to thus form an Ag-nanoweb layer laminated on an inner surface of the cover layer.

20. The method of claim 19, wherein a conductive metal layer is further laminated on an inner surface of the cover layer, wherein the spinning solution is electrospun on the conductive metal layer so that the Ag-nanoweb layer is laminated on the conductive metal layer.
